(19) United States
(12) Patent Application Publication
(10) Pub. No.: US 2024/0184529 A1
(43) Pub. Date: Jun. 6, 2024

(54) Apparatuses, Methods, Computer Systems and Computer-Readable Media For Generating and Using Random Values

(71) Applicants: Dan HOROVITZ, Rishon Lezion (IL); Alon HORN, Mishmar Haemek (IL); Ilil BLUM SHEM-TOV, Kiryat Tivon (IL); Shai HASARFATY, Jerusalem (IL); David NOVICK, BEAVERTON, OR (US)

(72) Inventors: Dan HOROVITZ, Rishon Lezion (IL); Alon HORN, Mishmar Haemek (IL); Ilil BLUM SHEM-TOV, Kiryat Tivon (IL); Shai HASARFATY, Jerusalem (IL); David NOVICK, BEAVERTON, OR (US)

(21) Appl. No.: 18/391,788

(22) Filed: Dec. 21, 2023

(51) Int. Cl. G06F 7/58

(52) U.S. Cl. CPC G06F 7/586

(57) ABSTRACT

Various examples of the present disclosure relate to apparatuses, methods, computer systems and computer-readable media for generating and using random values. Some aspects of the present disclosure relate to an apparatus for a computer system, the apparatus comprising memory circuitry, machine-readable instructions, and processor circuitry to execute the machine-readable instructions to determine different canary values for corresponding different threads of a program, and start the thread of the program, with the determined canary value being used as stack canary for the thread of the program.

### BACKGROUND

Stack canaries, named for their analogy to a canary in a coal mine, are used to detect a stack buffer overflow before execution of malicious code can occur. The stack canary method works by placing a small random value at each function prolog just before the stack return pointer (the value of which is expected to be randomly chosen at program start) and performing a check to detect if the random value gets overwritten during the epilog before the stack pointer returns to the caller function in memory. Most buffer overflows overwrite memory from lower to higher memory addresses, in order to overwrite the return pointer (and thus take control of the process). Because the canary memory location is part of that area, it is then overwritten. Checking the canary value on return validates that a memory write did not occur, so that the routine can be trusted and the return pointer on the stack can be used. This technique can greatly increase the difficulty of exploiting a stack buffer overflow because it forces the attacker to gain control of the instruction pointer by some non-traditional means such as corrupting other important variables on the stack.

There are two main ways of bypassing canaries—by leaking it through an information leakage vulnerability or by brute forcing the canary value—this is possible on 32-bit or less systems, and sometimes unavoidable (at the current time it is not, however, feasible on 64-bit systems). The brute force attack tries to overwrite the canary location with random values until the right value is guessed at which point the return address is used. If the canary is reused between products, then once the canary value is guessed, the value can be reused, making that attack a BORE (break once reuse everywhere) attack.

In the development of firmware IP (Intellectual Property) blocks that are integrated in SoCs (System on Chips) or are used as standalone IPs in products, this leads to a challenge in protecting such IP blocks against buffer overflows. One mechanism to protect against buffer overflows is to use stack canaries. If the IP is lacking a TRNG (True Random Number Generator) or a system TRNG access, then the stack canary mechanism might not be correctly implemented. In embedded environments, used by different IP blocks, without a dedicated TRNG the capability to generate a sufficiently random canary (that is protected from backtracking, and it is prediction resistant) may be missing for protecting the embedded systems stack from buffer overflows. Without a true pseudo random generator, the canary used by the stack canary mechanism can be deduced or predicted. Even if a fixed externally generated (platform level) true random generated canary is used, it can be brute forced, and if it is reused for all systems then it is vulnerable to BORE attacks (break once reuse for everyone). Even a unique per system generated random canary can be leaked by brute force, which is especially true for small size canary values that are commonly used in embedded systems where it is commonly set to no more than 32 bits in length (usually 24 bits). Current known processes to extract TRNG based randomness from a running system are slow in practice, with the added latency creating a large overhead on an embedded system's startup execution phase, rendering the approach impractical.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a computer system, and of a computer system comprising such an apparatus or device;

FIG. 1b shows a flow chart of an example of a method for a computer system;

FIG. 2a shows a schematic diagram of an example of an apparatus or device for a computer system, and of a computer system comprising such an apparatus or device;

FIG. 2b shows a flow chart of an example of a method for a computer system;

FIG. 3a shows a flow chart of an example of generating canary values without a true random number generator;

FIG. 3b shows a flow chart of another example of generating canary values according to the proposed concept, with dynamic regeneration (moving target approach);

FIG. 4a shows a schematic diagram of an example of an analog noise source;

FIG. 4b shows a schematic diagram of an example of a physical noise source; and

FIG. 4c shows a schematic diagram of an example of a non-physical noise source.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

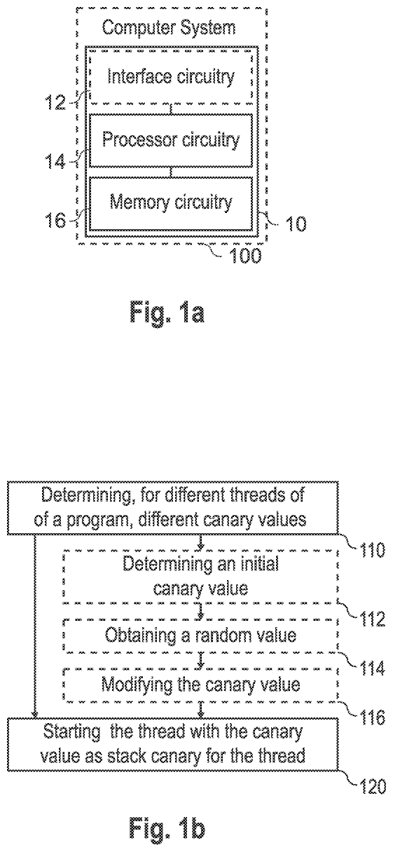

FIG. 1a shows a schematic diagram of an example of an apparatus 10 or device 10 for a computer system 100, and of a computer system 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises optional interface circuitry 12, processor circuitry 14, and memory circuitry 16. For example, the processor circuitry 14 may be coupled with the interface circuitry 12, and with the memory circuitry 16. For example, the processor circuitry 14 may provide the functionality of the apparatus, in conjunction with the interface circuitry 12 (for exchanging information, e.g., with other components inside or outside the computer system 100 comprising the apparatus 10 or device 10), the memory or storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, (optional) means for communicating 12, which may correspond to or be implemented by the interface circuitry 12, means for storing information 16, which may correspond to or be implemented by the memory circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory circuitry 16, a storage circuitry (not shown), or means for storing information 16.

The processor circuitry 14 or means for processing 14 is to determine different canary values for corresponding different threads of a program. For example, the processor circuitry 14 or means for processing 14 may determine, for each start of a thread of a program, a canary value, with a different canary value being determined for each start of a thread of the program. For example, the processor circuitry 14 or means for processing 14 is to start the thread of the program, with the determined canary value being used as stack canary for the thread of the program. For example, the processor circuitry may provide as a rule a new canary value for a different thread of the program. For example, the processor circuitry may obtain, for each start of a thread of a program, a canary value and an obtained canary value for a thread of the program may differ from previously used canary values of threads of the program in at least 20% (or at least 10%, or at least 50%) of starts of a thread of the program, and use the obtained canary value as stack canary for the thread of the program.

FIG. 1b shows a flow chart of an example of a corresponding method for a computer system, e.g., for the computer system 100. The method comprises method comprising determining 110 different canary values for corresponding different threads of a program. The method comprises starting 120 the thread of the program, with the determined canary value being used as stack canary for the thread of the program. For example, the method may be performed by the computer system 100, e.g., by the apparatus 10 or device 10 of the computer system 100. For example, the method may comprise obtaining, for each start of a thread of a program, a canary value, wherein an obtained canary value for a thread of the program may differ from previously used canary values of threads of the program in at least 20% (or at least 10%, or at least 50%) of starts of a thread of the program, and using the obtained canary value as stack canary for the thread of the program.

In the following, the functionality of the apparatus 10, device 10, computer system 100, method and of a corresponding computer program are introduced in more detail with reference to the apparatus 10. Features introduced in connection with the apparatus 10 may likewise be included in the corresponding device 10, computer system 100, method and computer program.

Various examples of the present disclosure are based on the finding, that, in lower-complexity computer systems, such as embedded devices, the protection against buffer overflows with the help of stack canaries can be impeded, as the bit-width being used for the stack canary (which may depend on the bit-width of the computer system, e.g., 32 bits or even 16 bits) can be susceptible to brute-force attacks. Similarly, many lower-complexity computer systems lack presence of a true random number generator, such that the generated value is either not entirely random and can be guessed more easily, or a random value is generated externally and is then used over a longer period of time (and possibly over multiple devices), making these devices more susceptible to attacks.

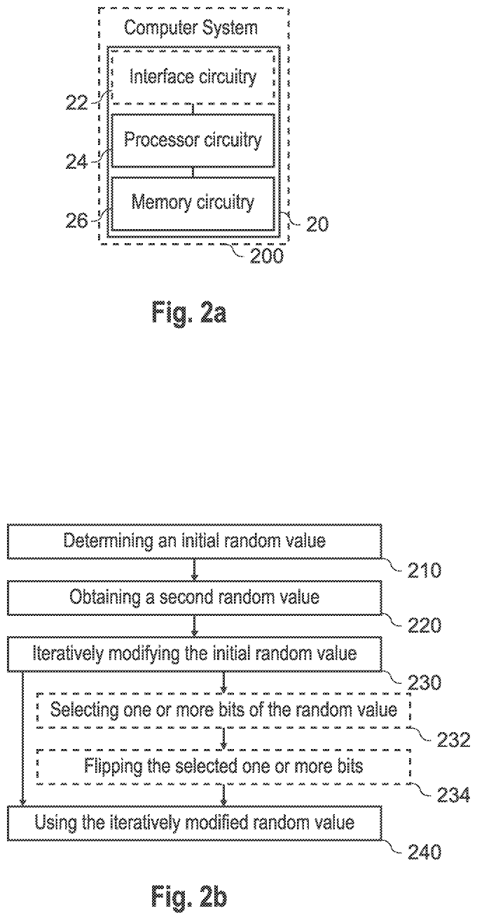

In the proposed concept, these drawbacks are overcome using two mechanisms—on the one hand, different stack canaries are used for different threads of a program, such that a stack canary being guessed is not detrimental to other threads, limiting the impact of an attack. On the other hand, to facilitate the generation of strong stack canary values (or, more generally, random values, as will be described in more generality in connection with FIGS. 2a and 2b) with a high level of randomness, the random value being used as stack canary can be iteratively modified based on a source of randomness/entropy, which may increase the randomness of the modified random value with each iteration, such that even relatively weak non-true random number generators can be used to, over time, generate random values with a sufficient level of randomness. As will be described in connection with FIGS. 2a and 2b, such random values can be used for other purposes aside from their use as stack canary.

When applied to the generation of canary values for use as stack canary, the proposed concept starts with determining different canary values for corresponding different threads of a program. This canary value may be derived from an initial seed, i.e., an initial canary value, which may be iteratively modified over time. In other words, the processor circuitry may determine an initial canary value, and then iteratively modify the canary value to determine the different canary values. Accordingly, as further shown in FIG. 1b, the method may comprise determining 112 the initial canary value, and iteratively modifying 116 the canary value to determine the different canary values. For example, in some cases, the initial canary value may be determined using a true random number generator (e.g., of the apparatus 10 or computer system 100). Alternatively, the initial canary value may be determined using a non-true random number generator (e.g., of the apparatus 10 or computer system 100). In the latter case, a pre-defined number of iterative modifications may be done before the canary value is used, to make sure that a desired level of randomness is reached.

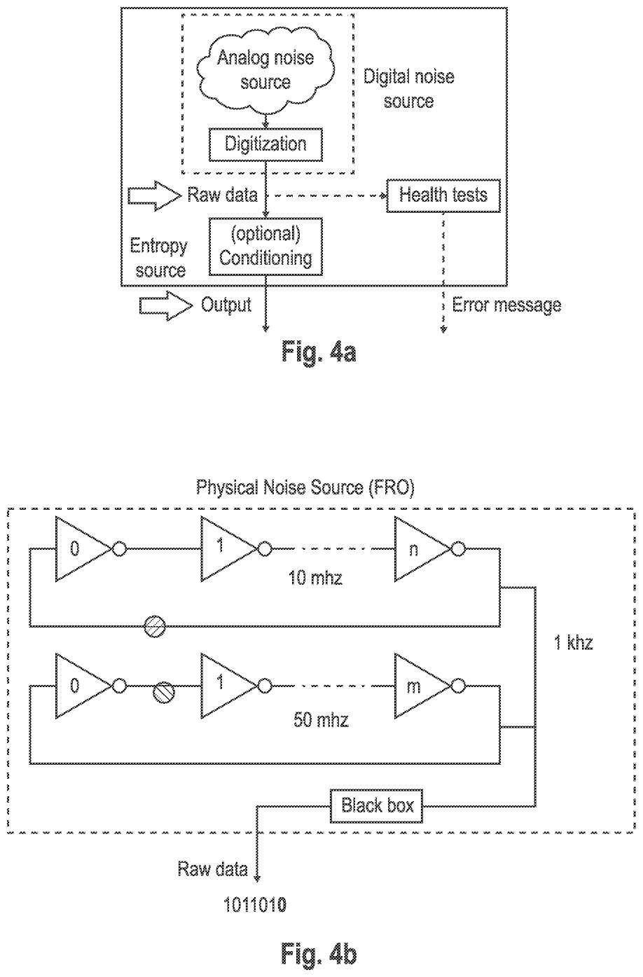

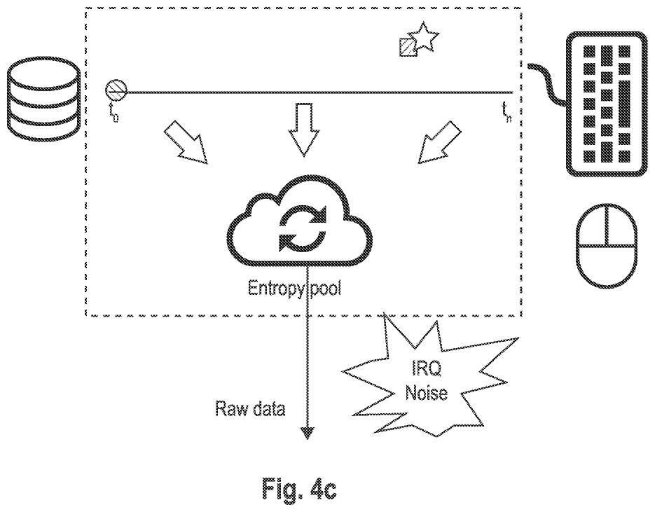

In the proposed concept, the requirements with respect to a source of randomness being used in the iterative modification of the canary value is relatively low, as the entropy (entropy is a measure of the disorder or randomness present in a system) or level of randomness iteratively increases over time as the canary value is iteratively updated. For example, in various examples of the proposed concept, a random value (denoted second random value in connection with FIGS. 2a and 2b and raw data in connection with FIGS. 4a to 4c) is obtained form a source of randomness, and then used to modify the canary value. In other words, the processor circuitry may, for (each) modification of the canary value, obtain a random value from a source of randomness, and modify the canary value using the random value. Accordingly, as further shown in FIG. 1b, the method may comprise, for (each) modification of the canary value, obtaining 114 a random value from a source of randomness, and modifying 116 the canary value using the random value. As the iterative approach is the main guarantee for the level of randomness, different types of (weak) sources of randomness may be used for this purpose. In particular, the source of randomness may be a non-true random generator, i.e., not a hardware True Random Number Generator (TRNG). In other words, the processor circuitry may obtain the random value from a non-true random value generator. For example, the non-true random value generator may be based on a clock drift between two clocks, e.g., the random value may represent the clock drift between the two clocks. Additionally, or alternatively, as shown in FIG. 4a, the non-true random value generator may be based on analog noise, e.g., based on a physical noise source (such as shown in FIG. 4b). For example, the non-true random number generator may provide the random value based on one of radioactive decay, thermal noise, shot noise, avalanche noise in Zener diodes, clock drift, the timing of actual movements of a hard disk read-write head, and radio noise. Alternatively, as shown in FIG. 4c, the non-true random value generator may be based on a non-physical noise source being based on an operation of the computer system. In this case, the non-true random value generator may use a timing of input of a keyboard, a movement of a pointer input device (e.g., a mouse), Interrupt Request (IRQ) noise, hard disk activity etc. as source of noise. In some cases, multiple sources of randomness (i.e., multiple sources of entropy) may be combined. In other words, the non-true random value generator may be based on multiple sources of randomness.

As the canary value is modified for different threads (with different threads being started hundreds of times or thousands of times in a short time span), the delay caused by generating and obtaining the random value may be kept low. Accordingly, the processor circuitry may obtain the random value from a source of randomness being capable of providing the random value within a pre-defined maximal time interval. For this reason, the random value might not be obtained from a true random number generator, which may cause a significant delay.

To apply the random value when modifying the canary value, different courses of actions may be chosen, depending on the bit length of the random value. For example, if the random value has the same number of bits as the canary value (or even more), the canary value and the random value may be XOR-ed together. If the random value has fewer bits than the canary value (e.g., only a few bits), other approaches may be chosen. For example, the processor circuitry may select, based on the random value, one or more bits of the canary value to flip, and flip the selected bits to modify the canary value. Accordingly, the method may comprise selecting, based on the random value, one or more bits of the canary value to flip, and flipping the selected bits to modify the canary value.

For example, if the random value has two bits, four different cases may be handled—if the two bits are 00—flip all, 01 flip every second bit, 10 flip every third bit, 11 flip every 4th bit, cycling back at the end of the variable etc. Such a scheme may be extended according to the number of bits included in the random value.

The generated canary values may then be applied as stack canary when starting new threads. In other words, the processor circuitry may start the thread of the program, with the determined canary value being used as stack canary for the thread of the program. In other words, the respective canary values may be placed at the function prolog(s) of the thread, just before the stack return pointer, to be used as stack canary with respect to the thread.

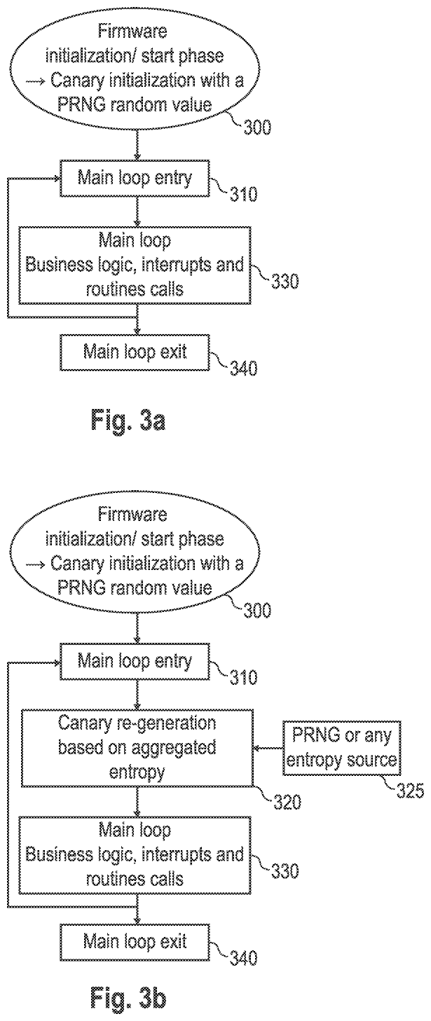

This concept can be used in different contexts. For example, in computer system firmware, a main loop is repeated over and over again. In the proposed concept, in each iteration or at least some iterations of a loop, the canary value may be modified, and a different canary value may be used as stack canary. In other words, the program may be part of a firmware of the computer system, with the firmware using a main loop during operation. This is shown in FIG. 3a, for example. For subsequent iterations of the main loop, different canary values are determined and used as stack canary. For example, before or upon entering the iteration of the main loop, the canary value may be modified and used, when starting threads inside the main loop, as stack canary. As the main loop repeats over and over again (e.g., thousands of times per second), the window of opportunity for using a canary value being guessed through brute force is minimal, improving the security of the firmware.

However, the proposed concept for making stack canaries more secure is not limited to firmware applications. For example, it can be used in user space as well. For example, a different stack canary may be used for different threads (e.g., a different canary value for each thread) of a user-space application (and, analogously, for different threads of different user-space applications). In other words, the program may be a user-space application. Different threads of the program may be started with different canary values as stack canary. For example, to further improve the security, the different canary values may be based on different initial canary values (i.e., based on different starting seeds).

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory circuitry 16 or means for storing information 16 may comprise volatile memory, e.g., random access memory, such as dynamic random-access memory (DRAM).

For example, the computer system 100 may be any kind of system comprising a processor, such as a laptop computer, a desktop computer, a server computer, an embedded computer, an Internet of Things node, a tablet computer, a mobile device, a smartphone etc.

More details and aspects of the apparatus 10, device 10, computer system 100, method and computer program are mentioned in connection with the proposed concept, or one or more examples described above or below (e.g., FIGS. 2a to 4c). The apparatus 10, device 10, computer system 100, method and computer program may comprise one or more additional optional features corresponding to one or more aspects of the proposed concept, or one or more examples described above or below.

FIG. 2a shows a schematic diagram of an example of an apparatus 20 or device 20 for a computer system 200, and of a computer system 200 comprising such an apparatus 20 or device. For example, the apparatus 20 or device 20 may be implemented similarly to the apparatus 10 or device 10 of FIG. 1a. The apparatus 20 comprises circuitry to provide the functionality of the apparatus 20. For example, the circuitry of the apparatus 20 may be configured to provide the functionality of the apparatus 20. For example, the apparatus 20 of FIG. 2a comprises optional interface circuitry 22, processor circuitry 24, and memory circuitry 26. For example, the processor circuitry 24 may be coupled with the interface circuitry 22, and with the memory circuitry 26. For example, the processor circuitry 24 may provide the functionality of the apparatus, in conjunction with the interface circuitry 22 (for exchanging information, e.g., with other components inside or outside the computer system 200 comprising the apparatus 20 or device 20), the memory or storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIG. 2a comprises means for processing 24, which may correspond to or be implemented by the processor circuitry 24, (optional) means for communicating 22, which may correspond to or be implemented by the interface circuitry 22, means for storing information 26, which may correspond to or be implemented by the memory circuitry 26. In general, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The apparatus 20 or device 20 may comprise the machine-readable instructions, e.g., within the memory circuitry 26, a storage circuitry (not shown), or means for storing information 26.

The processor circuitry 24 or means for processing 24 is to determine an initial random value. The processor circuitry 24 or means for processing 24 is to iteratively modify the initial random value based on a second random value obtained from a source of randomness. The processor circuitry 24 or means for processing 24 is to use the iteratively modified random value for a task requiring a random value.

FIG. 2b shows a flow chart of an example of a corresponding method for a computer system, e.g., for the computer system 200. The method comprises determining 210 the initial random value. The method comprises iteratively modifying 230 the initial random value based on the second random value obtained 220 from the source of randomness. The method comprises using 240 the iteratively modified random value for a task requiring a random value. For example, the method may be performed by the computer system 200, e.g., by the apparatus 20 or device 20 of the computer system 200.

In the following, the functionality of the apparatus 20, device 20, computer system 200, method and of a corresponding computer program are introduced in more detail with reference to the apparatus 20. Features introduced in connection with the apparatus 20 may likewise be included in the corresponding device 20, computer system 200, method and computer program.

In connection with FIGS. 1a and 1b, a specific use case for a random value was introduced—the use of a random value as stack canary. However, the technique described in connection with FIGS. 1a and 1b is not limited to its use for quickly generating stack canaries—this is merely one of the applications of the technique. In other words, the iteratively modified random value may be used as stack canary for a thread of a program. For example, different iteratively modified random values are used as stack canary for different threads of the program or for threads of different programs.

Alternate uses include use as part of address space layout randomization (ASLR). In other words, the iteratively modified random value may be used for address space layout randomization. Address Space Layout Randomization (ASLR) is a security technique that helps protect against buffer overflow attacks by randomizing the location where system and application code is loaded into memory. Each time an application starts, ASLR loads the application's executable and dynamic libraries at different memory locations, rather than at the same address every time. By doing so, ASLR adds a layer of unpredictability, making it harder for an attacker to execute arbitrary code through crafted exploits that rely on knowing the memory address of specific instructions or data structures. ASLR suffers from the same challenges on 32 bit and less platforms. Data ASLR and KASLR (Kernel ASLR) are additional mechanisms that not always available in embedded systems due the address memory space or limited randomness source.

In ASLR, various random values are used. For example, the iteratively modified random value may be used to determine a location in memory, into which an executable file is loaded upon starting of an application including the executable file. Additionally, or alternatively, the iteratively modified random value may be used to determine a location in memory, into which a library being used by the application is loaded. Additionally, or alternatively, the iteratively modified random value may be used to determine an area of memory used for the heap (heap randomization). Additionally, or alternatively, the iteratively modified random value may be used to determine a start position in the stack (stack randomization). Additionally, or alternatively, the iteratively modified random value may be used to determine a base address for memory-mapped files and shared memory regions (address space randomization).

The technique being used is the same as described in connection with FIGS. 1a and 1b—the process starts by determining the initial random value (using a TRNG or non-TRNG), which is then iteratively modified based on a second random value obtained from a source of randomness. The respective iteratively modified random values are then used, e.g., as stack canary or for ASLR.

For example, as outlined in connection with FIGS. 1a and 1b, the second random value (denoted random value in connection with FIGS. 1a and 1b and raw data in connection with FIGS. 4a to 4c) is obtained from a source of randomness, and then used to modify the initial random value. In other words, the processor circuitry may, for each modification of the random value, obtain the second random value from a source of randomness, and modify the random value using the random value. As the iterative approach is the main guarantee for the level of randomness, different types of (weak) sources of randomness may be used for this purpose. In particular, the source of randomness may be a non-true random generator, i.e., not a hardware True Random Number Generator (TRNG). In other words, the processor circuitry may obtain the second random value from a non-true second random value generator. For example, the non-true second random value generator may be based on a clock drift between two clocks, e.g., the second random value may represent the clock drift between the two clocks. Additionally, or alternatively, as shown in FIG. 4a, the non-true second random value generator may be based on analog noise, e.g., based on a physical noise source (such as shown in FIG. 4b). For example, the non-true random number generator may provide the second random value based on one of radioactive decay, thermal noise, shot noise, avalanche noise in Zener diodes, clock drift, the timing of actual movements of a hard disk read-write head, and radio noise. Alternatively, as shown in FIG. 4c, the non-true second random value generator may be based on a non-physical noise source being based on an operation of the computer system. In this case, the non-truc second random value generator may use a timing of input of a keyboard, a movement of a pointer input device (e.g., a mouse), Interrupt Request (IRQ) noise, hard disk activity etc. as source of noise. In some cases, multiple sources of randomness (i.e., multiple sources of entropy) may be combined. In other words, the non-true second random value generator may be based on multiple sources of randomness.

As the random value is modified for different starts of threads (which may occur hundreds of times or thousands of times in a short time span), the delay caused by generating and obtaining the second random value may be kept low. Accordingly, the processor circuitry may obtain the second random value from a source of randomness being capable of providing the second random value within a pre-defined maximal time interval. For this reason, the second random value might not be obtained from a true random number generator, which may cause a significant delay.

To apply the second random value when modifying the random value, different courses of actions may be chosen, depending on the bit length of the second random value. For example, if the second random value has the same number of bits as the random value (or even more), the random value and the second random value may be XOR-ed together. If the second random value has fewer bits than the random value (e.g., only a few bits), other approaches may be chosen. For example, the processor circuitry may select, based on the second random value, one or more bits of the random value to flip, and flip the selected bits to modify the random value. Accordingly, the method may comprise selecting 232, based on the second random value, one or more bits of the random value being iteratively modified to flip, and flipping 234 the selected bits to modify the random value.

For example, if the second random value has two bits, four different cases may be handled—if the two bits are 00—flip all, 01 flip every second bit, 10 flip every third bit, 11 flip every 4th bit, cycling back at the end of the variable etc. Such a scheme may be extended according to the number of bits included in the second random value.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processor circuitry 24 or means for processing 24 may be implemented using one or more processing units, one or more processing devices, any means for processing, such as a processor, a computer or a programmable hardware component being operable with accordingly adapted software. In other words, the described function of the processor circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory circuitry 26 or means for storing information 26 may comprise volatile memory, e.g., random access memory, such as dynamic random-access memory (DRAM).

For example, the computer system 200 may be any kind of system comprising a processor, such as a laptop computer, a desktop computer, a server computer, an embedded computer, an Internet of Things node, a tablet computer, a mobile device, a smartphone etc.

More details and aspects of the apparatus 20, device 20, method and computer program are mentioned in connection with the proposed concept, or one or more examples described above or below (e.g., FIG. 1a to 1b, 3a to 4c). The apparatus 20, device 20, method and computer program may comprise one or more additional optional features corresponding to one or more aspects of the proposed concept, or one or more examples described above or below.

Various examples of the present disclosure relate to a moving target defense against stack canary (random value) prediction attacks by continuously regeneration with a predefined strategy.

If an embedded system uses a stack canary mechanism, then, in most cases, one of the following approaches are used. For example, the embedded system may use a TRNG hardware (i.e., dedicated hardware IP). Adding a TRNG dedicated HW block is the best option but not always possible or economical. Alternatively, the embedded system may generate a true random value from running system characteristics (e.g., a physically unclonable function, PUF). However, deriving a TRNG from the running system is complex and usually introduces significant latency. Alternatively, the embedded system may use a random canary that is externally generated and fixed per each embedded system power cycle from an external source. However, externally generated, fixed canary values are reusable and subject to brute force and BORE (break once reuse everywhere) attacks especially if the bit length of the canary is small, which is common in embedded systems. Alternatively, the embedded system may reuse the same random canary that is externally generated as part of the IP, which may lead to weak security and thus compromise the entire product set using the same value (BORE). Alternatively, the embedded system may use the renew after fork StackSmash Protector (RAF-SSP), which provides a new random generation of the canary on each new thread\fork, used in user space by Microsoft\Linux—the proposed approach presents a modification of the RAF SSP (Re-new After Fork SSP) technique which consist on setting a new random value of the canary for each child process when the fork( ) system call is invoked.

The weakness of that method is that it depends on the fork call, and it is applicable per thread so when the execution time is long it isn't effective.

On embedded systems, the proposed approach comprises starting the firmware main loop (most of the firmware runs in a main loop and reacts to different interrupts or parses commands through a management interface. Even if such pattern is not applicable, the approach described here is still applicable with the only difference that the canary is generated each time a child thread is created in multi-threaded execution or per each process in multi-process execution case, e.g., at each execution cycle), with a PRNG (Pseudo Random Number Generator) canary value or using not-true RNG mechanism regardless the canary needed size (that is derived from architecture bit length). The actual canary may be derived from that seed every execution loop cycle to generate a onetime canary by mixing that common root with a system specific (observed) entropy source this makes the canary dynamic and continuously changing thus preventing BORE attacks. This approach is applicable to any system lacking TRNG resources and enables the use of a stack canary security defense mechanism against buffer overflows. It can also be used in systems with a low bit length where a fixed canary, even one that is generated by a TRNG persists for too long, thus allowing brute force attacks.

Non-true RNG source can be achieved by mixing different sources of entropy that may include radioactive decay, thermal noise, shot noise, avalanche noise in Zener diodes, clock drift, the timing of actual movements of a hard disk read-write head, and radio noise. However, physical phenomena and tools used to measure them generally feature asymmetries and systematic biases that make their outcomes not uniformly random—in our case that isn't a problem as the butterfly effect is applied by continuously deriving that source over the system execution. The more the system is run, the more random it becomes. A randomness extractor, such as a cryptographic hash function, can be used to approach a uniform distribution of bits from a non-uniformly random source, though at a lower bit rate.

The proposed approach provides a mechanism applicable to all systems lacking a TRNG (e.g., most embedded systems). On the other hand, using a TRNG has a performance impact as well. Besides providing a way to use a PRNG (pseudo random generator), the proposed concept improves the stack canary mechanism using a ‘moving target defense’ that is suitable for low bit size architectures (ex: 8\16\32 bit). Many IP blocks lack such a protection, resulting in weak canary implementations, which may carry the risk of brute force and BORE attacks. The proposed concept may improve the security of such IP blocks.

The proposed approach addresses the challenges of brute force attacks (which are a challenge in firmware implementations) or leaking the canary. The proposed approach is not only applicable to firmware implementations, but for also managed runtime environments—an improvement over other approaches. The approach further addresses the dependency on a local or system TRNG in the hardware domain that may impose a cost on performance and thus might not be used periodically. The proposed approach is based on dynamically changing the canary per invocation/call (the “moving target approach” against attackers), which is not yet in use today. The proposed concept provides an approach for generating random values (incrementally) in a software/firmware IP block when lacking a real random entropy source or even when the random entropy source is not large enough. The proposed concept provides an approach for generating random values incrementally based on a predefined strategy using a low source of randomness for reaching eventually to a random value with a desired level of randomness.

The following flow describes the proposed approach for generating canary value generation. First, a PRNG or non-true RNG source of entropy may be selected out of existing SoC resources e.g., entry time into primary loop, clock drift). This source may provide a pseudo-random number in very short time. Next, a canary value may be seeded to a platform specific random number set during manufacturing. This number may be mixed with a prior canary value at every firmware loop entry time (millions of times a sec). The result may be used as a canary value for every new function call. This flow may continue until the execution completes.

In firmware, the canary may be generated in each firmware execution cycle, with the generation being seeded incrementally in a very fast way. That technique greatly increases (several orders of magnitude) the difficulty of a brute attack as well as an information leaking attack in most systems. The proposed concept can rely on a source of entropy that might not be random enough to be used directly as a stack canary, but it is continuously changing and evolving, providing an ever-changing pseudo random source for creation of stack canaries. The resiliency of the proposed process to brute force guessing attacks is improved, as the value detected in a brute force cycle cannot be later used in a ‘real’ attack in the next execution cycles, making the brute force attacks useless.

FIGS. 3a and 3b show the current (FIG. 3a) model and the new (FIG. 3b) model. FIG. 3a shows a flow chart of an example of generating canary values without a true random number generator (according to the current model). At firmware initialization/start phase 300, the canary is initialized with a PRNG random value. Then the firmware enters 310 into the main loop, and the main loop (with business logic, interrupts and routine calls) is executed 330, looping back to the main loop entry 310. Finally, the main loop is exited 340. FIG. 3b shows a flow chart of another example of generating canary values according to the proposed concept, with dynamic regeneration (moving target approach). Compared to the approach shown in FIG. 3a, upon entering 310 the main loop, the canary is regenerated 320 based on aggregated entropy of a PRNG or any other entropy source 325 before the main loop is executed 330.

The proposed approach addresses the reuse of canary values between systems of the same product line, reuse of canary values in the same product across firmware (or software) cycles. It limits or removes the ability to apply brute strength attacks offline which is especially critical in systems with a low canary bit length size (ex: under 64 bit). In multithreaded environments, the same approach can be reused at thread level, but with another starting seed used to generate the random canary. If no physical entropy is available or even a PRNG (software based), a non-true RNG can be used. By iteratively modifying the canary value, the entropy may grow and change every main loop cycle.

For example, the system entropy rate may be defined as follows:

System entropy rate=System entropy/number of bits

With the proposed approach, if a lower number of bits was used at start than the system existing entropy, the system entropy rate grows exponentially the more the system operates:

System entropy rate=(System entropy/number of bits)^{number of firmware execution cycles}

The “System entropy” is fixed as the “number of bits” but the “system entropy rate” is increasing every new FW execution cycle due regeneration that happens every execution cycle.

In the following, an example is given for initial seed generation and for a re-seeding strategy. In a system with a random source TRNG/PRNG, those mechanisms may be used for an initial seed. In a system without a TRNG/PRNG random source, a non-true RNG source may be used (e.g., according to the examples listed below).

In the former strategy, it may be enough to have an at least two bits random entropy source. The se bits can be used for flipping a bit from the random variable (e.g., the canary) every XX bits, where XX is determined from the two bits generated (e.g., 00—flip all, 01 flip every second bit, 10 flip every third bit, 11 flip every 4th bit, cycling back at the end of the variable). This may be applied every cycle and, in a few cycles, will reach to the desired entropy.

In the second strategy, it may be enough to have at least two bits random entropy source. These bits can be used for XOR-ing two bits from the random variable (e.g., the canary). A counter may be used for each cycle. The counter can be used to shift to the next bits (after the previous two), cycling over all bits on the desired random variable. That flow may happen every cycle and, in few cycles, will reach the desired entropy.

Additional strategies exist and can be defined based on random source size, random value desired and system requirements.

In the following, some examples are given of non-true RNG source that can be used with the proposed concept, e.g., integrated within the respective apparatus.

For example, two clocks (e.g., a Phase-Locked Loop and an oscillator) may be operated, and a clock drift between the two clocks may be used as source of entropy (e.g., 1000 cycles. 0.05% drift . . . ).

FIG. 4a shows a schematic diagram of an example of an analog noise source being used as a source of entropy. An output of the analog noise source is digitized, thus providing a digital noise source. The output of the digitization (i.e., the digital noise source) may be further conditioned. Health tests may be performed on the output of digitization.

FIG. 4b shows a schematic diagram of an example of a physical noise source. In FIG. 4b, two sequential combinations of inverters, operated at different clock frequencies, are fed at a sampling rate being different from the two clock frequencies into a black box being used to process the output of the two sequential combinations of inverters, providing raw random data.

FIG. 4c shows a schematic diagram of an example of a non-physical noise source. In the non-physical noise source of FIG. 4c, random input, such as hard disk access, keyboard input or mouse input are used as entropy pool (e.g., in the form of or combined with Interrupt Request noise) to provide raw data.

More details and aspects of the moving target defense are mentioned in connection with the proposed concept, or one or more examples described above or below (e.g., FIG. 1a to 2b). The moving target defense may comprise one or more additional optional features corresponding to one or more aspects of the proposed concept, or one or more examples described above or below.

In the following, some examples of the proposed concept are presented:

An example (e.g., example 1) relates to an apparatus (10, 20) for a computer system, the apparatus comprising memory circuitry (16, 26), machine-readable instructions, and processor circuitry (14, 24) to execute the machine-readable instructions to determine different canary values for corresponding different threads of a program, and start the thread of the program, with the determined canary value being used as stack canary for the thread of the program. For example, the processor circuitry may execute the machine-readable instructions to obtain, for each start of a thread of a program, a canary value, wherein an obtained canary value for a thread of the program differs from previously used canary values of threads of the program in at least 20% of starts of a thread of the program, and to use the obtained canary value as stack canary for the thread of the program.

Another example (e.g., example 2) relates to a previous example (e.g., example 1) or to any other example, further comprising that the program is part of a firmware of the computer system, with the firmware using a main loop during operation, wherein, for subsequent iterations of the main loop, different canary values are determined and used as stack canary.

Another example (e.g., example 3) relates to a previous example (e.g., one of the examples 1 or 2) or to any other example, further comprising that the program is a user-space application, wherein different threads of the program are started with different canary values as stack canary.

Another example (e.g., example 4) relates to a previous example (e.g., example 3) or to any other example, further comprising that the different canary values are based on different initial canary values and/or based on different starting seeds.

Another example (e.g., example 5) relates to a previous example (e.g., one of the examples 1 to 4) or to any other example, further comprising that the processor circuitry is to execute the machine-readable instructions to determine an initial canary value, and to iteratively modify the canary value to determine the different canary values.

Another example (e.g., example 6) relates to a previous example (e.g., example 5) or to any other example, further comprising that the processor circuitry is to execute the machine-readable instructions to, for (each) modification of the canary value, obtain a random value from a source of randomness, and to modify the canary value using the random value.

Another example (e.g., example 7) relates to a previous example (e.g., example 6) or to any other example, further comprising that the processor circuitry is to execute the machine-readable instructions to select, based on the random value, one or more bits of the canary value to flip, and to flip the selected bits to modify the canary value.

Another example (e.g., example 8) relates to a previous example (e.g., one of the examples 6 or 7) or to any other example, further comprising that the processor circuitry is to execute the machine-readable instructions to obtain the random value from a non-true random value generator.

Another example (e.g., example 9) relates to a previous example (e.g., example 8) or to any other example, further comprising that the non-true random value generator is based on a clock drift between two clocks.

Another example (e.g., example 10) relates to a previous example (e.g., one of the examples 8 or 9) or to any other example, further comprising that the non-true random value generator is based on analog noise.

Another example (e.g., example 11) relates to a previous example (e.g., one of the examples 8 to 10) or to any other example, further comprising that the non-true random value generator is based on a physical noise source.

Another example (e.g., example 12) relates to a previous example (e.g., one of the examples 8 to 11) or to any other example, further comprising that the non-true random value generator is based on a non-physical noise source being based on an operation of the computer system.

Another example (e.g., example 13) relates to a previous example (e.g., one of the examples 8 to 12) or to any other example, further comprising that the non-true random value generator is based on multiple sources of randomness.

Another example (e.g., example 14) relates to a previous example (e.g., one of the examples 6 to 13) or to any other example, further comprising that the processor circuitry is to execute the machine-readable instructions to obtain the random value from a source of randomness being capable of providing the random value within a pre-defined maximal time interval.

Another example (e.g., example 15) relates to a previous example (e.g., one of the examples 5 to 14) or to any other example, further comprising that the processor circuitry is to execute the machine-readable instructions to determine the initial canary value using a true random number generator.

Another example (e.g., example 16) relates to a previous example (e.g., one of the examples 5 to 15) or to any other example, further comprising that the processor circuitry is to execute the machine-readable instructions to determine the initial canary value using a non-true random number generator.

An example (e.g., example 17) relates to an apparatus (10, 20) for a computer system, the apparatus comprising memory circuitry (16, 26), machine-readable instructions, and processor circuitry (14, 24) to execute the machine-readable instructions to determine an initial random value, iteratively modify the initial random value based on a second random value obtained from a source of randomness, use the iteratively modified random value for a task requiring a random value.

Another example (e.g., example 18) relates to a previous example (e.g., example 17) or to any other example, further comprising that the iteratively modified random value is used as stack canary for a thread of a program.

Another example (e.g., example 19) relates to a previous example (e.g., example 18) or to any other example, further comprising that different iteratively modified random values are used as stack canary for different threads of the program or for threads of different programs.

Another example (e.g., example 20) relates to a previous example (e.g., one of the examples 17 to 19) or to any other example, further comprising that the iteratively modified random value is used for address space layout randomization.

Another example (e.g., example 21) relates to a previous example (e.g., one of the examples 17 to 20) or to any other example, further comprising that the processor circuitry is to execute the machine-readable instructions to select, based on the second random value obtained from the source of randomness, one or more bits of the random value being modified to be flipped, and to flip the selected bits of the random value.

Another example (e.g., example 22) relates to a previous example (e.g., one of the examples 17 to 21) or to any other example, further comprising that the processor circuitry is to execute the machine-readable instructions to obtain the second random value from a non-true random value generator.

Another example (e.g., example 23) relates to a previous example (e.g., example 22) or to any other example, further comprising that the non-true random value generator is based on a clock drift between two clocks.

Another example (e.g., example 24) relates to a previous example (e.g., one of the examples 22 or 23) or to any other example, further comprising that the non-true random value generator is based on analog noise.

Another example (e.g., example 25) relates to a previous example (e.g., one of the examples 22 to 24) or to any other example, further comprising that the non-true random value generator is based on a physical noise source.

Another example (e.g., example 26) relates to a previous example (e.g., one of the examples 22 to 25) or to any other example, further comprising that the non-true random value generator is based on a non-physical noise source being based on an operation of the computer system.

Another example (e.g., example 27) relates to a previous example (e.g., one of the examples 22 to 26) or to any other example, further comprising that the non-true random value generator is based on multiple sources of randomness.

Another example (e.g., example 28) relates to a previous example (e.g., one of the examples 17 to 27) or to any other example, further comprising that the processor circuitry is to execute the machine-readable instructions to obtain the second random value from a source of randomness being capable of providing the random value within a pre-defined maximal time interval.

An example (e.g., example 29) relates to a method for a computer system, the method comprising determining (110) different canary values for corresponding different threads of a program, and starting (120) the thread of the program, with the determined canary value being used as stack canary for the thread of the program. For example, the method may comprise obtaining, for each start of a thread of a program, a canary value, wherein an obtained canary value for a thread of the program differs from previously used canary values of threads of the program in at least 20% of starts of a thread of the program, and using the obtained canary value as stack canary for the thread of the program.

Another example (e.g., example 30) relates to a previous example (e.g., one of the examples 29 to 32) or to any other example, further comprising that the method comprises determining (112) an initial canary value, and iteratively modifying (116) the canary value to determine the different canary values.

Another example (e.g., example 31) relates to a previous example (e.g., example 33) or to any other example, further comprising that the method comprises, for (each) modification of the canary value, obtaining (114) a random value from a source of randomness, and modifying (116) the canary value using the random value.

Another example (e.g., example 32) relates to a previous example (e.g., example 34) or to any other example, further comprising that the method comprises selecting, based on the random value, one or more bits of the canary value to flip, and flipping the selected bits to modify the canary value.

An example (e.g., example 33) relates to a method (10, 20) for a computer system, the method comprising determining (210) an initial random value, iteratively modifying (230) the initial random value based on a second random value obtained (220) from a source of randomness, and using (240) the iteratively modified random value for a task requiring a random value.

Another example (e.g., example 34) relates to a previous example (e.g., one of the examples 45 to 48) or to any other example, further comprising that the method comprises selecting (232), based on the second random value obtained from the source of randomness, one or more bits of the random value being modified to be flipped, and flipping (234) the selected bits of the random value.

An example (e.g., example 35) relates to an apparatus (10, 20) for a computer system, the apparatus comprising processor circuitry (14, 24) configured to determine different canary values for corresponding different threads of a program, and start the thread of the program, with the determined canary value being used as stack canary for the thread of the program. For example, the processor circuitry may obtain, for each start of a thread of a program, a canary value, wherein an obtained canary value for a thread of the program differs from previously used canary values of threads of the program in at least 20% of starts of a thread of the program, and use the obtained canary value as stack canary for the thread of the program.

An example (e.g., example 36) relates to an apparatus (10, 20) for a computer system, the apparatus comprising processor circuitry (14, 24) configured to determine an initial random value, iteratively modify the initial random value based on a second random value obtained from a source of randomness, and use the iteratively modified random value for a task requiring a random value.

An example (e.g., example 37) relates to an apparatus (10, 20) for a computer system, the apparatus comprising means for processing (14, 24) for determining different canary values for corresponding different threads of a program, and starting the thread of the program, with the determined canary value being used as stack canary for the thread of the program. For example, the means for processing may be for obtaining, for each start of a thread of a program, a canary value, wherein an obtained canary value for a thread of the program differs from previously used canary values of threads of the program in at least 20% of starts of a thread of the program, and using the obtained canary value as stack canary for the thread of the program.

An example (e.g., example 38) relates to an apparatus (10, 20) for a computer system, the apparatus comprising means for processing (14, 24) for determining an initial random value, iteratively modifying the initial random value based on a second random value obtained from a source of randomness, and using the iteratively modified random value for a task requiring a random value.

Another example (e.g., example 39) relates to a non-transitory, computer-readable medium comprising a program code that, when the program code is executed on a processor, a computer, or a programmable hardware component, causes the processor, computer, or programmable hardware component to perform at least one of the method of one of the examples 29 to 32 (or according to any other example) and the method of one of the examples 33 or 34 (or according to any other example).

Another example (e.g., example 40) relates to a non-transitory machine-readable storage medium including program code, when executed, to cause a machine to perform the method of one of the examples 29 to 32 (or according to any other example) and/or the method of one of the examples 33 or 34 (or according to any other example).

Another example (e.g., example 41) relates to a computer program having a program code for performing at least one of the method of one of the examples 29 to 32 (or according to any other example) and the method of one of the examples 33 or 34 (or according to any other example), when the computer program is executed on a computer, a processor, or a programmable hardware component.

Another example (e.g., example 42) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a computer system, the apparatus comprising memory circuitry, machine-readable instructions, and processor circuitry to execute the machine-readable instructions to:
determine different canary values for corresponding different threads of a program; and
start the thread of the program, with the determined canary value being used as stack canary for the thread of the program.

2. The apparatus according to claim 1, wherein the program is part of a firmware of the computer system, with the firmware using a main loop during operation, wherein, for subsequent iterations of the main loop, different canary values are determined and used as stack canary.

3. The apparatus according to claim 1, wherein the program is a user-space application, wherein different threads of the program are started with different canary values as stack canary.

4. The apparatus according to claim 3, wherein the different canary values are based on different initial canary values and/or based on different starting seeds.

5. The apparatus according to claim 1, wherein the processor circuitry is to execute the machine-readable instructions to determine an initial canary value, and to iteratively modify the canary value to determine the different canary values.

6. The apparatus according to claim 5, wherein the processor circuitry is to execute the machine-readable instructions to, for modification of the canary value, obtain a random value from a source of randomness, and to modify the canary value using the random value.

7. The apparatus according to claim 6, wherein the processor circuitry is to execute the machine-readable instructions to select, based on the random value, one or more bits of the canary value to flip, and to flip the selected bits to modify the canary value.

8. The apparatus according to claim 6, wherein the processor circuitry is to execute the machine-readable instructions to obtain the random value from a non-true random value generator.

9. The apparatus according to claim 8, wherein the non-true random value generator is based on a clock drift between two clocks.

10. The apparatus according to claim 8, wherein the non-true random value generator is based on analog noise.

11. The apparatus according to claim 8, wherein the non-true random value generator is based on a physical noise source.

12. The apparatus according to claim 8, wherein the non-true random value generator is based on a non-physical noise source being based on an operation of the computer system.

13. The apparatus according to claim 8, wherein the non-true random value generator is based on multiple sources of randomness.

14. The apparatus according to claim 6, wherein the processor circuitry is to execute the machine-readable instructions to obtain the random value from a source of randomness being capable of providing the random value within a pre-defined maximal time interval.

15. The apparatus according to claim 5, wherein the processor circuitry is to execute the machine-readable instructions to determine the initial canary value using a true random number generator.

16. The apparatus according to claim 5, wherein the processor circuitry is to execute the machine-readable instructions to determine the initial canary value using a non-true random number generator.

17. A method for a computer system, the method comprising:
obtaining, for each start of a thread of a program, a canary value, wherein an obtained canary value for a thread of the program differs from previously used canary values of threads of the program in at least 20% of starts of a thread of the program; and
starting the thread of the program, with the obtained canary value being used as stack canary for the thread of the program.

18. The method according to claim 17, wherein the method comprises determining an initial canary value, and iteratively modifying the canary value to obtain the different canary values.

19. The method according to claim 18, wherein the method comprises, for modification of the canary value, obtaining a random value from a source of randomness, and modifying the canary value using the random value.

20. A non-transitory, computer-readable medium comprising a program code that, when the program code is executed on a processor, a computer, or a programmable hardware component, causes the processor, computer, or programmable hardware component to:
determine different canary values for corresponding different threads of a program; and
start the thread of the program, with the determined canary value being used as stack canary for the thread of the program.
